(19) United States
(12) Patent Application Publication
(10) Pub. No.: US 2017/0198852 A1
(43) Pub. Date: Jul. 13, 2017

(54) Heatable Tube

(71) Applicant: ContiTech Techno-Chemie GmbH, Karben (DE)

(72) Inventors: Gunther Daniel, Friedberg (DE); Joachim Stein, Friedberg (DE)

(73) Assignee: ContiTech Techno-Chemie GmbH, Karben (DE)

(21) Appl. No.: 15/321,387

(22) PCT Filed: May 18, 2015
(86) PCT No.: PCT/EP2015/060828

§ 371 Date: Dec. 22, 2016

(30) Foreign Application Priority Data
Jul. 25, 2014 (DE) 10 2014 214 690.9

(51) Int. Cl. F16L 53/00; H05B 3/56; H05B 3/14; H05B 3/04; H05B 3/06

(52) U.S. Cl. CPC F16L 53/008; H05B 3/04; H05B 3/06; H05B 3/145; H05B 3/56; H05B 2203/015; H05B 2203/02; H05B 2203/021; H05B 2203/022; H05B 2214/02; H05B 2214/04

(57) ABSTRACT

The invention relates to a heatable tube (1) for conducting fluid, gaseous and/or pasty media, comprising an outer wall (10) that encloses an inner volume (11), and a heating element (2) which is arranged inside the inner volume (11) and which includes a first heating conductor (20a) and a second heating conductor (20b). The heatable tube (1) is characterized in that the first heating conductor (20a) and the second heating conductor (20b) are connected to one another by a heating conductor connector (20c) so as to form a loop in such a way that one heating conductor (20a, 20b) acts as a feed conductor (20a, 20b) and the other heating conductor (20a, 20b) acts as a return conductor (20a, 20b).

The invention relates to a heatable hose for conducting fluid, gaseous and/or pasty media, as per the preamble of claim 1, and to a motor vehicle having a heatable hose of said type, as per claim 15.

Heatable hoses are known in a wide variety of embodiments, in particular as electrically heatable hoses, for example for use in motor vehicles. Alternatively, heatable hoses are known in the case of which a heated medium, for example in the form of a liquid, is used. Depending on the temperature of said medium in relation to the medium conducted in the hose, the latter medium can be heated or even cooled. The medium flowing in said hoses between two connector points is heated or cooled by said hoses.

One application for this is for example the heating of urea-based liquids such as are used for the exhaust-gas aftertreatment of automobile diesel engines for the reduction of the nitrogen oxides, known as SCR technology (selective catalytic reduction). Such an additive is known under the trade name AdBlue®. The heating may be necessary because the additive freezes at temperatures below approximately minus 10° C.

An electrically heatable hose having at least one electrical heating conductor which serves for heating a medium flowing in the hose is known for example from DE 102 01 920 A1, wherein the heating conductor extends over at least a partial region of the length of the hose and is composed of a metallic core and of a casing. The heating conductor is normally embedded in a layer of the hose. In the case of a multi-layer hose, the heating conductor may also be arranged between two layers. In the case of this type of heating of the fluid, the electrical heating conductor heats all of the hose material surrounding it.

A disadvantage here is that only a part of the heating power is transmitted into the interior of the hose and thus to the fluid. A part of the heating power is however transmitted outward and is released, unutilized, to the surroundings, that is to say said fraction of the heating power constitutes a loss. This can rather give rise to undesired heating of other vehicle components which come into contact with or absorb heat from the heatable hose.

The use of heatable hoses is also known for windshield washing installations for the purposes of preventing the freezing of the washing water or thawing out the frozen washing water water more quickly or in the first place. In the case of such relatively thin hoses, the heating conductor is led within the hose line with a casing which electrically insulates it with respect to the washing water. The encased heating conductor is in this case arranged loosely within the internal volume of the hose, in effect floating freely in the washing water. At the ends of the hose line, the encased heating conductor is led out of the washing water for example at the connectors. These passages of the encased heating conducted through the connectors are normally sealed off by way of O-rings composed of elastomer material or by way of an elastomer body.

EP 2 706 208 A1 relates to a plug connector having a housing which has a receiving space, a connector piece and a duct which connects the receiving space and the connector piece, wherein a heating zone is provided in the interior of the duct. For the fast heating of a liquid line having a plug connector of said type, it is provided that a heat-conducting element is arranged between the heating zone and the receiving space. The heat element extends into the receiving space. A seal arrangement in the form of two O-rings is arranged in the receiving space, and the heat element extends through the seal arrangement.

EP 2 527 704 A1 relates to a connector for a fluid line having a housing which has a connector piece, which is connectable to a pipe, and a connection geometry, which is connectable to a counterpart element. To be able to lead an auxiliary element out of a fluid line and keep the risk of leakage low, it is provided that the housing has an outlet opening through which at least one auxiliary element is led out of the housing to the outside, wherein the auxiliary element is led through an elastomer body which, under the action of pressure parallel to the passing-through direction of auxiliary element through the elastomer body, expands perpendicularly to the passing-through direction and is possibly held on the outlet opening by way of a holder device. The holder device may have a cap which at least partially covers the outlet opening and which may be screwed, snapped, pressed, adhesively bonded or welded onto the housing.

An advantage of said encased heating conductor arranged in the fluid in relation to the arrangement within the outer wall of the hose is that the electrically generated heat is released entirely to the washing water surrounding the heating conductor.

However, the arrangement of the heating conductor arranged in the fluid cannot be transferred to the use of urea-based liquids in the SCR field, because said liquids would chemically and/or physically attack both the casing of the heating conductor and also the seal composed of elastomer material. The former situation would lead to a degradation, to the point of destruction, of the heating conductor, and the latter situation would lead to leaks.

It is an object of the present invention to provide a heatable hose of the type described in the introduction, the heating conductor of which is arranged in the internal volume of the hose and which can be produced as easily as possible and so as to be as leakproof as possible.

The object is achieved according to the invention by way of a heatable hose for conducting fluid, gaseous and/or pasty media, having the features of claim 1, and by way of a motor vehicle having the features of claim 15. Advantageous developments are described in the dependent claims.

Thus, the present invention relates to a heatable hose for conducting fluid, gaseous and/or pasty media, of an outer wall, which encloses an internal volume, and a heating element, which is arranged within the internal volume. This is advantageous because, in this way, the heating element is in direct contact with the medium and can release its heating power over its full extent, directly and in the best possible manner to said medium. This reduces the heat losses to the surroundings and increases the efficiency of the heatable hose. In the case of a cylindrical hose, the heating element is of correspondingly cylindrical form and floats, as it were, freely in the medium, for example a fluid urea solution of an SCR system.

The heating element has a first heating conductor and a second heating conductor. The heating conductors may be medium-guiding conductors, for example in the form of hoses, in which a heated medium, such as for example a liquid, is conducted. As electrical heating conductors, said heating conductors are firstly electrically conductive in order to be able to conduct electrical current, but secondly exhibit such a high electrical resistance that sufficient electrical current heat losses are generated in order to sufficiently heat the surrounding medium for the respective usage situation.

The electrical heating conductors may be metallic or textile conductors. For example, an electrical heating conductor may comprise an alloy composed of chromium-nickel or copper, or may be composed of said alloy alone or may be composed of said unalloyed material. It is advantageous here that said metals exhibit a similarly high electrical resistance and, in this way, it is possible for higher electrical current heat losses to be generated than with metals with low electrical resistance. As textile conductors, use may be made of materials which exhibit electrical conductivity but which at the same time have the flexibility of a textile material. The textile conductors may have fibers which may be monofilaments or multifilaments, which may be in the form of a yarn or thread. These may form a linear textile conductor or may be in the form of a textile sheetlike structure. As material, use may be made of carbons such as carbon fibers or carbon nanotubes.

The heatable hose is characterized in that the first heating conductor and the second heating conductor are connected to form a loop by way of a heating conductor connection, such that one heating conductor forms a forward conductor and the other heating conductor forms a return conductor.

In this way, the two heating conductors form, by way of the heating conductor connection, a loop which is closed on one side. If fluid-guiding hoses are used as heating conductors, the fluid can flow into the heating element through the first heating conductor as forward conductor, is diverted there by the heating conductor connection, and can flow out of the heating element again through the second heating conductor as return conductor. For this purpose, the two heating conductors are, at their respectively open ends, provided for being connected to components which, for example by way of a pump, ensure the fluid flow and supply to the fluid the heat which said fluid, as it flows through the heating element, releases to said heating element and to the fluid surrounding the heating element. Here, as a result of said release of heat, the temperature of the fluid decreases from the inlet into the forward conductor to the outlet from the return conductor.

This arrangement can also be used for the cooling of the fluid in the hose, which would then be referred to as a coolable hose. Said hose would then have cooling conductors which would conduct a cooled fluid through the cooling element. The arrangement of the elements would however be identical to the described use as a heatable hose.

If electrical heating conductors are used as heating conductors, it is likewise possible, in the case of a supply of direct current, for the first heating conductor, as forward conductor, to conduct the electrical current into the heating element and for the second heating conductor, as return conductor, to conduct the electrical current out of the heating element again. In this case, the two electrical heating conductors must be connected to an electrical current or voltage source. If alternating current or alternating voltage is used, the two heating conductors alternate in terms of their function as forward conductor and return conductor with the frequency of the alternating current or of the alternating voltage.

Here, the invention is based on the realization that, owing to the loop-like connection of the two heating conductors by way of the heating conductor connection on one side of the heatable hose, it is possible for connectors to be dispensed with. This simplifies the construction and production of the heatable hose and simplifies the seal of the heating element with respect to the surroundings. At the same time, the arrangement, known for example for window wiper installations, of a heating element for heating the washing water, specifically arranged within the medium to be heated, can be refined easily and inexpensively for use with SCR technology, and in this way, the advantages of the as far as possible direct and complete release of heat to the urea liquid can be utilized in that field also.

According to one aspect of the present invention, the heating element is led into the internal volume through at least one first adapter element. By way of said first adapter element, the heatable hose can be connected to other hoses and/or assemblies. Said adapter element is preferably a so-called quick connector. To dispense with further elements, the heating element is led out of and into the internal volume of the hose through the first adapter element, such that only the connections between hose and first adapter element and between first adapter element and heating element have to be sealed off.

According to a further aspect of the present invention, the heating conductor connection is arranged on the opposite side of the first adapter element in relation to the internal volume. In other words, the heating conductor connection is arranged outside the internal volume. In this way, the heating conductor connection is easily accessible from the outside for the purposes of its production during the assembly process or its later inspection, maintenance or repair. Here, the heating conductor element may be led out through the first adapter element, and the two heating conductors are then exposed and equipped with the heating conductor connection, which may for example be in the form of an element that can be plugged on. Alternatively, the heating conductive connection may also have already been produced in advance, such that the heating conductor is led with the end of the heating conductor connection out of the first adapter element.

According to a further aspect of the present invention, the heating conductor connection is arranged on the same side of the first adapter element as the internal volume. In other words, the heating conductor connection is arranged within the internal volume. In this way, it is possible to dispense with a leadthrough through the first adapter element, whereby it is possible to dispense with a seal at that location. This eliminates leakage problems at that location. For the secure positioning of the heating conductor, said heating conductor may be fastened, by way of its end with the heating conductor connection, from the inside to the first adapter element.

According to a further aspect of the present invention, the first heating conductor, the second heating conductor and the heating conductor connection are an electrically conductive cable, an electrically conductive thread or an electrically conductive element. A cable is to be understood to mean a metallic conductor, composed preferably of copper, which may be composed of one or more preferably twisted-together strands. An electrically conductive thread is a textile electrically conductive element composed for example of an electrically conductive plastics material. An electrically conductive element may for example be a substantially punctiform heating element to which a feed is provided by way of electrical supply lines and which releases its heating power locally, whereas a cable or a thread has a uniform cross section and releases its heating power substantially uniformly over its length.

According to a further aspect of the present invention, the first heating conductor, the second heating conductor and the heating conductor connection are a PTC resistor. A PTC (Positive Temperature Coefficient) resistor has a current-conducting material which can conduct the current more effectively at relatively low temperatures than at high temperatures. The electrical resistance thereof increases with rising temperature. This type of resistor thus has a positive temperature coefficient. This is advantageous for this application because the electrical heating conductor and the heating conductor connection are intended to be operated in a heated environment, that is to say they are, during their use, permanently exposed to, and operated in, their own heat.

According to a further aspect of the present invention, the outer wall has an elastomer, a plastic, in particular a polyamide (PA), in particular PA 12, or polypthalamide (PPA) or polyphenylene sulfide (PPS), or a polyurethane. The use of elastomers is advantageous owing to their elasticity. The use of plastics and in particular polyamides is advantageous owing to their excellent strength and ductility. Furthermore, they exhibit good chemical and physical resistance with respect to organic solvents, and can be easily processed. In particular owing to its chemical and physical resistance, polyamide 12 is suitable, and has been tried and tested, for use with the medium urea solution. For example, PA 12 exhibits good hydrolysis resistance, such that, even with permanent use over for example 3000 h to 5000 h, the physical characteristic values of the material deteriorate to a relatively lesser extent than in the case of other polyamides. The plastics PPA and PPS are suitable for usage situations at relatively high temperatures, and can furthermore be (laser-)welded in a highly effective manner.

According to a further aspect of the present invention, the first heating conductor and the second heating conductor or the first heating conductor, the second heating conductor and the heating conductor connection are in each case individually or jointly surrounded with respect to the internal volume by a first heating conductor insulator. In this way, it is possible to realize chemical and/or physical, in particular electrical, insulation between the fluid to be heated in the internal volume and the heating conductors with heating conductor connection.

According to a further aspect of the present invention, the first heating conductor insulator has a fluorocarbon, a perfluoro (ethylene propylene) plastic (FEP), a modified fluoroalkoxy (MFA) or a perfluoroalkoxy alkane (PFA). Fluorocarbons are distinguished by their water-repellent nature. The use of FEP (also referred to as fluorinated ethylene propylene), which is used as a water-repellent coating for flexible substrates, is particularly advantageous.

According to a further aspect of the present invention, the first heating conductor and the second heating conductor or the first heating conductor, the second heating conductor and the heating conductor connection are in each case individually or jointly surrounded with respect to the internal volume by a second heating conductor insulator which surrounds the first heating conductor insulator.

The second heating conductor insulator makes it possible for the latter to be designed with regard to its insulating effect with respect to the medium that is conducted in the internal volume, without modification of the existing construction of the electrical heating conductor and of its first heating conductor insulator. This simplifies the usage, and reduces the costs.

The design of the second heating conductor insulator may be performed for example with regard to the chemical resistance for example with respect to a fluid urea solution of an SCR system. Alternatively or in addition, the design may be performed with regard to the greatest possible thermal conductivity in order that the heat from the electrical heating conductor can be transmitted with the least possible losses, and as quickly as possible, to the medium. Alternatively or in addition, the design may be performed with regard to high pressure resistance, if the medium is conducted at high pressure.

The joint encasement of the two heating conductors with heating conductor connection simplifies the construction of the heating element and holds the two heating conductors together. The separate encasement of the two heating conductors with heating conductor connection increases the heat output because the fluid to be heated can also pass between the doubly encased heating conductors.

According to a further aspect of the present invention, the second heating conductor insulator has an elastomer, a plastic, in particular a polyamide (PA), in particular PA 12, or polypthalamide (PPA) or polyphenylene sulfide (PPS), or a polyurethane. The same characteristics and advantages as already described above with respect to the outer wall apply to the heating conductor insulator.

According to a further aspect of the present invention, the outer wall and at least the second heating conductor insulator are connected by way of the first adapter element and/or a second adapter element. By way of said adapter element, the electrically heatable hose can be connected to other elements such as further hoses or assemblies. Here, the adapter element also has a passage in order to make it possible for the fluid to be conducted into the internal volume and out of the internal volume and exchanged with the other hoses or assemblies. The adapter element is preferably a quick-action connecting element (quick connector) which simplifies and thereby expedites the mounting of the electrically heatable hose.

According to a further aspect of the present invention, the first adapter element and/or the second adapter element has an adapter body which is connected to the second heating conductor insulator by way of a cohesive connection. Said cohesive connection intensifies the sealing action of said connection, such that the sealing action is maintained in particular in the presence of relatively high pressures of the medium. Furthermore, it is possible to dispense with separate seal elements such as for example an O-ring, which simplifies the construction.

According to a further aspect of the present invention, the cohesive connection is a laser-welded connection, a rotary-welded connection or an adhesive connection. All of these connection types lead to a pressure-resistant connection. Laser welding and rotary welding are used preferably in the case of a second heating conductor insulator composed of polyamide, and an adhesive connection is used in particular in the case of a second heating conductor insulator composed of elastomer material.

The present invention also relates to a motor vehicle having a heatable hose as described above. In this way, the advantages described above can be utilized in a motor vehicle, in particular in an SCR system of a motor vehicle.

Three exemplary embodiments and further advantages of the invention will be discussed below in conjunction with the following figures. In the figures:

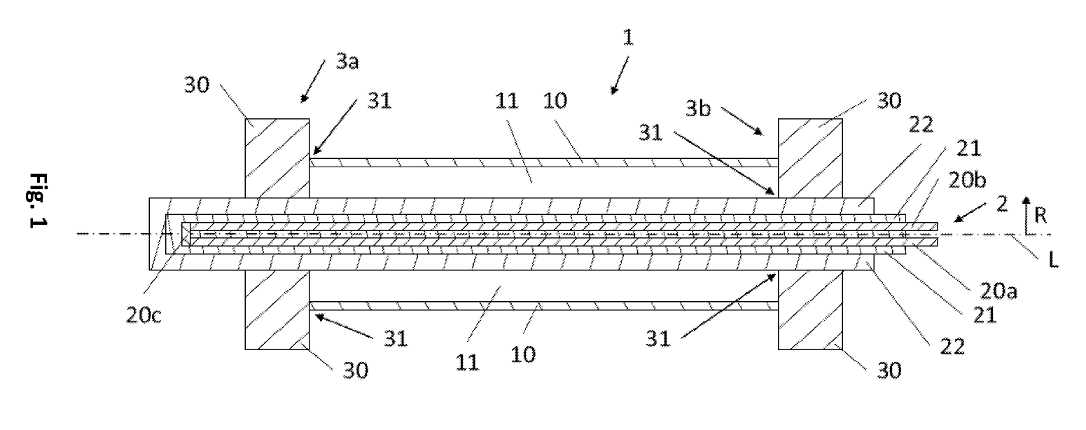

FIG. 1 is a schematic sectional illustration of a heatable hose according to the invention as per a first embodiment;

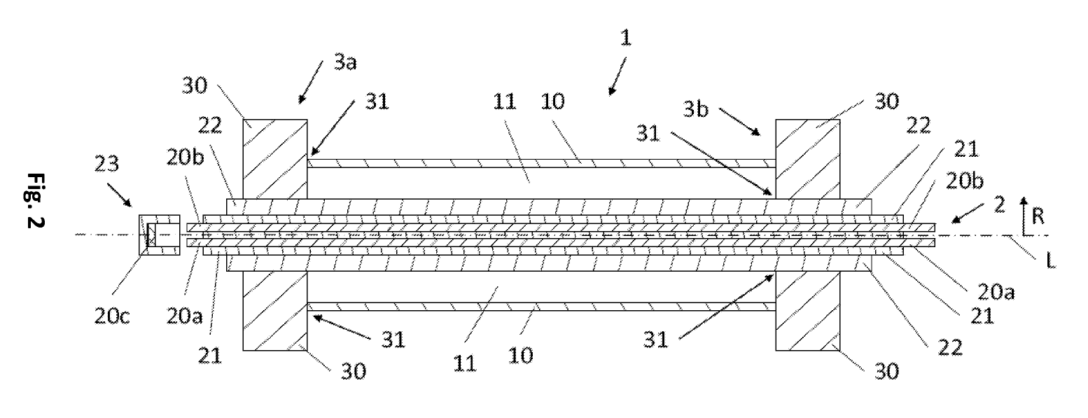

FIG. 2 is a schematic sectional illustration of a heatable hose according to the invention as per a second embodiment; and

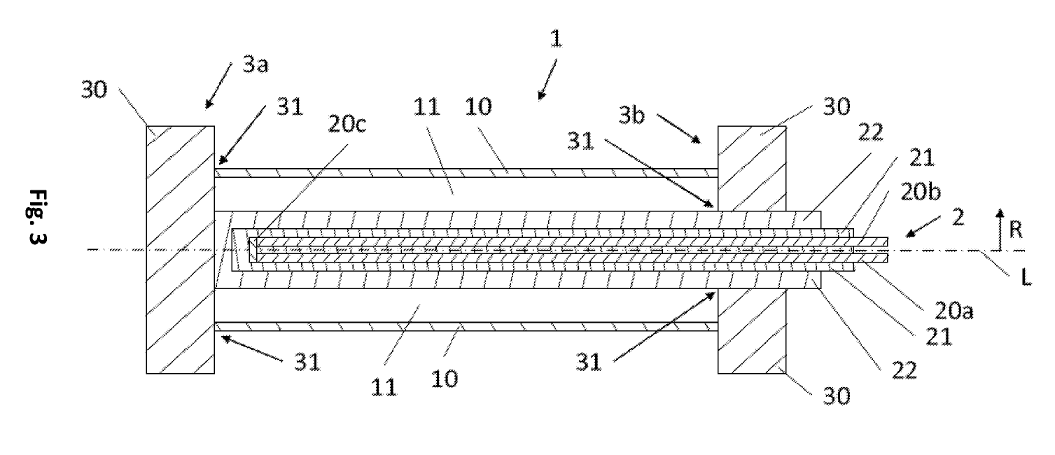

FIG. 3 is a schematic sectional illustration of a heatable hose according to the invention as per a third embodiment.

FIG. 1 is a schematic sectional illustration of a heatable hose 1 according to the invention as per a first embodiment. The heatable hose 1 is of cylindrical form along a longitudinal axis L. The heatable hose 1 is illustrated as being closed, with a first adapter element 3a at its left-hand end and with a second adapter element 3b at its right-hand end.

The heatable hose 1 has an elastic outer wall 10 composed of an elastomer material, which elastic outer wall encloses an internal volume 11 which is delimited on both sides by the adapter elements 3a, 3b. A medium such as for example a fluid can be conducted within said internal volume 11. In the case of an SCR system, the SCR hose 1 conducts an aqueous urea solution as fluid.

A heating element 2 in the form of an electrical heating element 2 is arranged, on the longitudinal axis L, in as far as possible freely floating fashion in the internal volume 11 or fluid, which heating element is arranged so as to be uniformly spaced apart in a radial direction R from the inner side of the outer wall 10. This arrangement is however illustrated schematically for better comprehension, because the freely floating electrical heating element 2 adapts to the profile of the hose 1, which may also be curved depending on the application.

The electrical heating element 2 has a first electrical heating conductor 20a and a second electrical heating conductor 20b in the form of thin copper cables or thin copper-containing cables through which current can flow in order to generate electrical heat losses and, by means thereof, heat the fluid in the internal volume 11. In the case of a supply of direct current (not illustrated), the first electrical heating conductor 20a forms the forward conductor, and the second electrical heating conductor 20b forms the return conductor. The two electrical heating conductors 20a, 20b are connected to one another in current-conducting fashion by way of a heating conductor connection 20c, such that said electrical heating conductors together form one electrical heating conductor 20a, 20b which is arranged in loop-shaped form within the heating conductor 2. In this way, the electrical connectors may be provided on one side of the heatable hose 1.

The two electrical heating conductors 20a, 20b and the heating conductor connection 20c are jointly encased by a first heating conductor insulator 21 which substantially chemically insulates said electrical heating conductors with respect to liquids and which at the same time permits a good transfer of heat to the internal volume 11. Furthermore, the first heating conductor insulator 21 is lined with a second heating conductor insulator 22 which additionally in particular chemically insulates the first heating conductor insulator 21 with respect to the internal volume 11 or the fluid such as for example the aqueous urea solution. In this way, the advantage of the direct transfer of heat of the freely floating electrical heating element 2 can also be utilized in usage situations with chemically aggressive fluids such as the aqueous urea solution of an SCR system. The electrical heating conductors 20a, 20b and the heating conductor connection 20c are in this case completely enclosed, as far as the connectors on the right-hand side, by the two heating conductor insulators 21, 22, such that fluid-tight insulation can be realized.

The adapter elements 3a, 3b have in each case one adapter body 30 which is connected to the second heating conductor insulator 22 in pressure-tight fashion by way of a cohesive connection 31, such as for example a laser-welded or rotary-welded connection 31 or an adhesive connection 31. Via the adapter bodies 3a, 3b, the fluid can be exchanged between the internal volume 11 and the surroundings, such as for example other hoses or assemblies (not illustrated).

FIG. 2 is a schematic sectional illustration of a heatable hose 1 according to the invention as per a second embodiment. In this case, the heating conductor connection 20c is arranged in a separate closure element 23 which is mounted onto the end of the two heating conductors 20a, 20b on the left-hand side after said heating conductors have been led out of the internal volume 11 through the first adapter element 3a. In this way, the heating conductor can be produced in a continuous length and can be cut to size and processed for the respective application, which can make the production process simpler and cheaper.

The closure by way of the heating conductor connection 20c is then realized, on the finished product, by way of the closure element 23.

FIG. 3 is a schematic sectional illustration of a heatable hose 1 according to the invention as per a third embodiment. In this case, the heating conductor 2 is designed as in the first embodiment, but ends within the internal volume 11 at the inner side of the first adapter element 3a. At this location, the heating conductor 2 can be fastened in preferably cohesive fashion. In this way, it is possible to dispense with a passage through the first adapter element 3a, which at the same time rules out leakage problems at said passage.

In all three embodiments, the two heating conductors 20a, 20b are jointly encased firstly by the first heating conductor insulator 21 and then by the second heating conductor insulator 22. Alternatively, the two heating conductors 20a, 20b may also be in each case spatially separately encased by the same first heating conductor insulator 21 or else by different first heating conductor insulators 21 and then by the common second heating conductor insulator 22 which, in this case, separates the two first heating conductor insulators 21 from one another, that is to say is also arranged between 20a and 20b. This can simplify the production because the two heating conductors 20a, 20b with their respective first heating conductor insulator 21 can be produced separately and are thereafter brought together for the first time within the second heating conductor insulator 22. It is also possible for the second heating conductor insulator 22 to encase the two heating conductors 20a, 20b separately, such that a spacing can form between these.

### LIST OF REFERENCE SIGNS

### (Part of the Description)

L Longitudinal axis
R Radial direction, perpendicular to longitudinal axis L
1 (Electrically) heatable hose, SCR hose
10 Outer wall
11 Internal volume
2 (Electrical) heating element
20a First (electrical) heating conductor, forward conductor
20b Second (electrical) heating conductor, return conductor
20c Heating conductor connection
21 First heating conductor insulator
22 Second heating conductor insulator
23 Closure element
3a First adapter element, first connector element, first quick connector
3b Second adapter element, second connector element, second quick connector
30 Adapter body, connector body
Cohesive connection between second heating conductor insulator 22 and adapter body 30, laser-welded connection, rotary-welded connection, adhesive connection

1.-15. (canceled)

16. A heatable hose comprising:
an outer wall which encloses an internal volume; and,
a heating element which is arranged within the internal volume, the heating element comprising a first heating conductor and a second heating conductor;
wherein the first heating conductor and the second heating conductor are connected to form a loop by way of a heating conductor connection, such that the first heating conductor forms a forward conductor and the second heating conductor forms a return conductor.

17. The heatable hose as claimed in claim 16, wherein the heating element is led into the internal volume through at least one first adapter element.

18. The heatable hose as claimed in claim 17, wherein the heating conductor connection is arranged on the opposite side of the at least one first adapter element in relation to the internal volume.

19. The heatable hose as claimed in claim 17, wherein the heating conductor connection is arranged on the same side of the at least one first adapter element as the internal volume.

20. The heatable hose as claimed in claim 16, wherein the first heating conductor, the second heating conductor and the heating conductor connection are one of an electrically conductive cable, an electrically conductive thread or an electrically conductive element.

21. The heatable hose as claimed in claim 20, wherein the first heating conductor, the second heating conductor and the heating conductor connection are a PTC resistor.

22. The heatable hose as claimed in claim 16, wherein the outer wall comprises polyamide, polypthalamide, polyphenylene sulfide, or polyurethane.

23. The heatable hose as claimed in claim 16, wherein the first heating conductor and the second heating conductor are individually or jointly surrounded with respect to the internal volume by a first heating conductor insulator.

24. The heatable hose as claimed in claim 23, wherein a second heating conductor insulator surrounds the first heating conductor insulator.

25. The heatable hose as claimed in claim 16, wherein the first heating conductor, the second heating conductor and the heating conductor connection are individually or jointly surrounded with respect to the internal volume by a first heating conductor insulator.

26. The heatable hose as claimed in claim 25, wherein a second heating conductor insulator surrounds the first heating conductor insulator.

27. The heatable hose as claimed in claim 16, further comprising a first heating conductor insulator comprising perfluoro (ethylene propylene) plastic, modified fluoroalkoxy or perfluoroalkoxy alkane.

28. The heatable hose as claimed in claim 27, further comprising a second heating conductor insulator comprising polyamide, polypthalamide, polyphenylene sulfide, or polyurethane.

29. The heatable hose as claimed in claim 28, further comprising a first adapter element and a second adapter element, wherein the outer wall and at least the second heating conductor insulator are connected by way of one or both of the first adapter element and the second adapter element.

30. The heatable hose as claimed in claim 29, wherein one or both of the first adapter element and the second adapter element comprises an adapter body which is connected to the second heating conductor insulator by way of a cohesive connection.

30. The heatable hose as claimed in claim 30, wherein the cohesive connection is a laser-welded connection, a rotary-welded connection, or an adhesive connection.

31. A heatable hose comprising:
an outer wall which encloses an internal volume; and,
a heating element which is arranged within the internal volume, the heating element comprising a first heating conductor and a second heating conductor;
wherein the first heating conductor and the second heating conductor are connected to form a loop by way of a heating conductor connection, such that the first heating conductor forms a forward conductor and the second heating conductor forms a return conductor; and,
wherein the first heating conductor, the second heating conductor and the heating conductor connection are a PTC resistor.

32. The heatable hose as claimed in claim 31, wherein the heating element is led into the internal volume through at least one first adapter element.

33. The heatable hose as claimed in claim 32, wherein the heating conductor connection is arranged on the opposite side of the at least one first adapter element in relation to the internal volume.

34. The heatable hose as claimed in claim 32, wherein the heating conductor connection is arranged on the same side of the at least one first adapter element as the internal volume.

35. A heatable hose comprising:
an outer wall which encloses an internal volume; and,
a heating element which is arranged within the internal volume, the heating element comprising a first heating conductor and a second heating conductor;
a first adapter element and a second adapter element;
a first heating conductor insulator comprising perfluoro (ethylene propylene) plastic, modified fluoroalkoxy or perfluoroalkoxy alkane; and,
a second heating conductor insulator comprising polyamide, polypthalamide, polyphenylene sulfide, or polyurethane;
wherein the first heating conductor and the second heating conductor are connected to form a loop by way of a heating conductor connection, such that the first heating conductor forms a forward conductor and the second heating conductor forms a return conductor;
wherein the outer wall and at least the second heating conductor insulator are connected by way of one or both of the first adapter element and the second adapter element; and,
wherein one or both of the first adapter element and the second adapter element comprises an adapter body which is connected to the second heating conductor insulator by way of a cohesive connection.
